(19) United States
(12) Patent Application Publication
(10) Pub. No.: US 2008/0015716 A1
(43) Pub. Date: Jan. 17, 2008

(54) Detachable Audio Module And Media Player Including The Same

(75) Inventor: Duck Soo LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Neofidelity , Inc., Seoul (KR)

(21) Appl. No.: 11/769,840

(22) Filed: Jun. 28, 2007

(30) Foreign Application Priority Data
Jul. 12, 2006 (KR) 10-2006-65318

(51) Int. Cl. G06F 17/00

(52) U.S. Cl. 700/94

(57) ABSTRACT

A detachable audio module and a media player including the same are disclosed. In accordance with the detachable audio module and the media player including the same, an audio signal and a control signal is received via a wired communication when the detachable audio module is attached to the reproduction transmitter module and via a wireless communication when the detachable audio module is detached from the reproduction transmitter module to provide an automatic wireless linking function.

### BACKGROUND OF THE INVENTION

1. Field of the Invention

The present invention relates to a detachable audio module and a media player including the same, and in particular, to a detachable audio module and a media player including the same wherein an audio signal and a control signal is received via a wired communication when the detachable audio module is attached to the reproduction transmitter module and via a wireless communication when the detachable audio module is detached from the reproduction transmitter module.

2. Description of the Related Art

Recently, a popularity of media players for a reproduction of various media files such as a portable media player (PMP), an MP3 player and a mobile phone is drastically increasing.

In case of the media player, an ultimate object thereof is to reduce a size thereof to improve a portability. Various semiconductor devices such as a semiconductor memory for storing the media file and a decoder chip are installed in the media player, and an LCD or OLED is installed for a display outside the media player. Reducing the size of the media player is limited due to the various semiconductor devices. When a number of the semiconductor devices are reduced, a quality of sound is degraded.

### SUMMARY OF THE INVENTION

It is an object of the present invention to provide a detachable audio module and a media player including the same wherein an audio signal and a control signal is received via a wired communication when the detachable audio module is attached to the reproduction transmitter module and via a wireless communication when the detachable audio module is detached from the reproduction transmitter module.

In order to achieve the above-described object, there is provided a media player apparatus comprising: a detachable audio module for receiving and playing back an audio signal; and a reproduction transmitter module electrically connected to the detachable audio module for transmitting the audio signal and a control signal to the detachable audio module, wherein the detachable audio module receives the audio signal and the control signal via a wired communication when attached to the reproduction transmitter module to reproduce the audio signal, wherein the detachable audio module receives the audio signal and the control signal via a wireless communication when detached from the reproduction transmitter module to reproduce the audio signal, and wherein the detachable audio module switches from the wired communication to the wireless communication when separated from the reproduction transmitter module.

It is preferable that the detachable audio module comprises: an audio module controller for carrying out a control of the detachable audio module and decoding the received audio signal; an amplifier module for amplifying the decoded audio signal; an wired/wireless interface module for connecting to the reproduction transmitter module via the wired communication or the wireless communication; and a power supply module for providing a power to the audio module controller, the amplifier module and the wired/wireless interface module.

Preferably, the power supply module receives a power from a power supply means disposed in the reproduction transmitter module when the detachable audio module is connected to the reproduction transmitter module via the wired communication.

It is preferable that the power supply module comprises: a rechargeable battery for storing a supplied power; and a charger module for charging the rechargeable battery with a power provided from a power supply means disposed in the reproduction transmitter module according to a remaining amount of the supplied power in the rechargeable battery.

Preferably, the charger module controls the power supply module in a manner that rechargeable battery is charged or provides the power to the power supply means disposed in the reproduction transmitter module according to the remaining amount of the supplied power in the rechargeable battery and a remaining amount of the power in the power supply means disposed in the reproduction transmitter module when the detachable audio module is connected to the reproduction transmitter module via the wired communication.

It is preferable that the power supply module further comprises a rechargeable power input for receiving an external power.

Preferably, the detachable audio module further comprises a built-in speaker and an external speaker output interface module for playing back a signal being outputted from the amplifier module.

It is preferable that the detachable audio module further comprises a microphone for receiving a voice signal.

Preferably, the wired/wireless interface module comprises at least one of a WiFi module, a bluetooth module and an RF module for communicating with the reproduction transmitter module, and comprises an interface connector for communicating with the reproduction transmitter module via the wired communication.

It is preferable that the amplifier module comprises: a DAC (Digital-to-Analog converter) module for converting the decoded audio signal into an analog signal; and an analog amplifier for amplifying the analog signal and outputting the amplified analog signal to a speaker.

Preferably, the amplifier module comprises a digital amplifier module for outputting the decoded audio signal to a speaker.

It is another object of the present invention to provide a detachable audio module detachable from a reproduction module, the audio module comprising: an wired/wireless interface module for transceiving an audio signal and a control signal to and from the reproduction module via a wired communication or the wireless communication; an audio module controller for carrying out a control of the detachable audio module and decoding the received audio signal; an amplifier module for amplifying the decoded audio signal; and a power supply module for providing a power to the audio module controller, the amplifier module and the wired/wireless interface module, wherein the detachable audio module receives the audio signal and the control signal via the wired communication when attached to the reproduction module to reproduce the audio signal, wherein the detachable audio module receives the audio signal and the control signal via a wireless communication when detached from the reproduction transmitter module to reproduce the audio signal, and wherein the detachable audio module switches from the wired communication to the wireless communication when separated from the reproduction transmitter module.

It is preferable that the power supply module receives a power from a power supply means disposed in the reproduction module when the detachable audio module is connected to the reproduction module via the wired communication.

Preferably, the power supply module comprises: a rechargeable battery for storing a supplied power; and a charger module for charging the rechargeable battery with a power provided from a power supply means disposed in the reproduction transmitter module according to a remaining amount of the supplied power in the rechargeable battery.

It is preferable that the charger module controls the power supply module in a manner that rechargeable battery is charged or provides the power to the power supply means disposed in the reproduction transmitter module according to the remaining amount of the supplied power in the rechargeable battery and a remaining amount of the power in the power supply means disposed in the reproduction transmitter module when the detachable audio module is connected to the reproduction transmitter module via the wired communication.

Preferably, the power supply module further comprises a rechargeable power input for receiving an external power.

It is preferable that the detachable audio module further comprises a built-in speaker and an external speaker output interface module for playing back a signal being outputted from the amplifier module.

Preferably, the wired/wireless interface module comprises at least one of a WiFi module, a bluetooth module and an RF module for communicating with the reproduction transmitter module, and comprises an interface connector for communicating with the reproduction transmitter module via the wired communication.

It is preferable that the amplifier module comprises: a DAC module for converting the decoded audio signal into an analog signal; and an analog amplifier for amplifying the analog signal and outputting the amplified analog signal to a speaker.

Preferably, the amplifier module comprises a digital amplifier module for outputting the decoded audio signal to a speaker.

### BRIEF DESCRIPTION OF THE DRAWINGS

FIG. 1 is a diagram illustrating a media player including a detachable audio module in accordance with the present invention.

FIG. 2 is a diagram illustrating a media player including a reproduction transmitter module in accordance with the present invention.

FIG. 3 is a block diagram illustrating a detachable audio module in accordance with the present invention.

FIG. 4 is a block diagram illustrating a power supply module of a detachable audio module in accordance with the present invention.

FIG. 5 is a block diagram illustrating a wired/wireless interface module of a detachable audio module in accordance with the present invention.

FIG. 6 is a block diagram illustrating an audio module controller of a detachable audio module in accordance with the present invention.

FIG. 7 is a block diagram illustrating another example of an audio module controller of a detachable audio module in accordance with the present invention.

### DETAILED DESCRIPTION OF THE INVENTION

The above-described objects and other objects and characteristics and advantages of the present invention will now be described in detail with reference to the accompanied drawings.

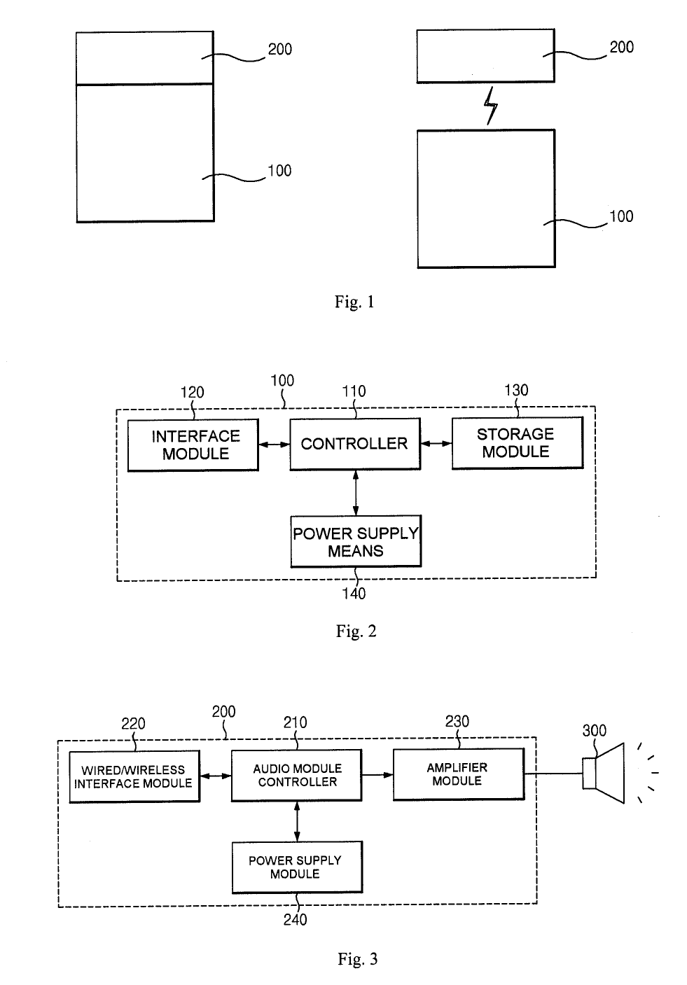

FIG. 1 is a diagram illustrating a media player including a detachable audio module in accordance with the present invention.

Referring to FIG. 1, the media player in accordance with the present invention comprises a reproduction transmitter module 100 and a detachable audio module 200.

The detachable audio module 200 receives an audio signal and a control signal via a wired communication when attached to the reproduction transmitter module 100, and reproduces the audio signal. The detachable audio module 200 receives the audio signal and the control signal via a wireless communication when detached from the reproduction transmitter module 100 and reproduces the audio signal. The detachable audio module 200 is capable of switching from the wired communication to the wireless communication at the moment of separation from the reproduction transmitter module 100.

Each component of the media player will be described below.

FIG. 2 is a diagram illustrating the media player including the reproduction transmitter module in accordance with the present invention.

Referring to FIG. 2, the reproduction transmitter module 100 comprises a controller 110 for carrying out an overall control of the reproduction transmitter module 100 and generating the control signal, a storage module 130 for storing digital audio files, an interface module 120 for communicating with the detachable audio module 200 and a power supply means 140.

The controller 110 reads the digital audio files stored in the storage module 130 and transmits the same to the detachable audio module 200 through the interface module 120 via the wired communication or the wireless communication. The power supply means 140 comprises a rechargeable battery and a charger module for providing a power to the reproduction transmitter module 100. The power supply means 140 provides the power to the detachable audio module 200 when the detachable audio module 200 is connected to the reproduction transmitter module the reproduction transmitter module 100 via the wired communication, i.e. when the detachable audio module 200 is attached to the reproduction transmitter module 100.

When the detachable audio module 200 is detached from the reproduction transmitter module 100, the controller 110 immediately recognizes the detachment and then controls the interface module 120 to automatically establish the wireless communication with the detachable audio module 200 (automatic wireless linking function). When the wireless communication is established, the detachable audio module 200 receives the audio signal and the control signal from the reproduction transmitter module 100 and reproduces the digital audio according to the control signal.

The media player may include but not limited to a mobile phone or a PMP (portable media player). The media player may include various apparatus for playing back various digital media.

FIG. 3 is a block diagram illustrating the detachable audio module in accordance with the present invention.

Referring to FIG. 3, the detachable audio module 200 comprises an audio module controller 210, an amplifier module 230, a wired/wireless interface module 220 and a power supply module 240. In addition, the detachable audio module 200 may further comprise a built-in speaker 300 and an external speaker output interface module. Moreover, although not shown, the detachable audio module 200 in accordance with the present invention may further include a microphone for receiving a voice signal.

The audio module controller 210 carries out an overall control of the detachable audio module 200, and decodes the received audio signal. Although not shown, the audio module controller 210 may include various components for the control and the decoding such as a CPU and a memory.

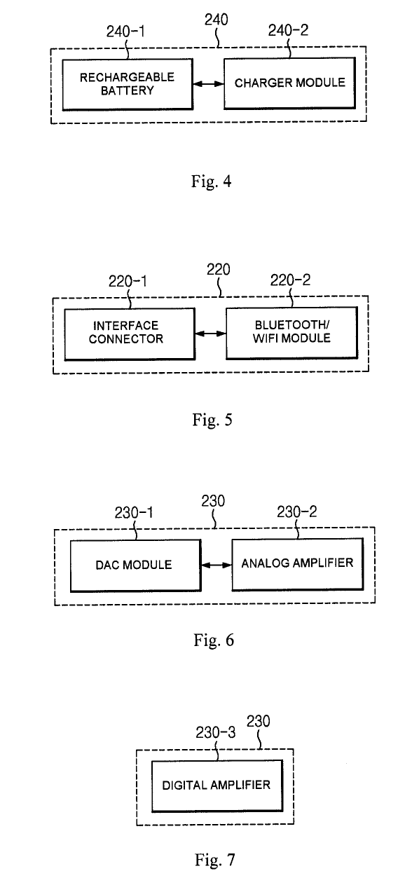

As shown in FIG. 4, the power supply module 240 for providing a power to the audio module controller 210, the amplifier module 230 and the wired/wireless interface module 220 comprises a rechargeable battery 240-1 for storing a supplied power and a charger module 240-2 for charging the rechargeable battery 240-1 with a power provided from the power supply means 140 disposed in the reproduction transmitter module 100 according to a remaining amount of the supplied power stored in the rechargeable battery 240-1.

The rechargeable battery 240-1 may include various secondary batteries such as a Nickel-Cadmium battery, a Nickel metal hydride battery, a Lithium-ion battery and Lithium-polymer battery.

The charger module 240-2 controls the power supply module 240 in a manner that rechargeable battery 240-1 is charged or provides the power to the power supplying means 140 disposed in the reproduction transmitter module 100 according to the remaining amount of the supplied power in the rechargeable battery 240-1 and a remaining amount of the power in the power supplying means 140 disposed in the reproduction transmitter module 100 when the detachable audio module 200 is connected to the reproduction transmitter module 100 via the wired communication. That is, the charger module 240-2 is capable of a bidirectional charging according to the remaining amount of the rechargeable battery.

In addition, the power supply module 240 may receive the power from the power supply means 140 disposed in the reproduction transmitter module 100 when connected via the wired communication.

As shown in FIG. 5, the wired/wireless interface module 220 comprises at least one of a WiFi module, a bluetooth module 220-2 and an RF module for communicating with the reproduction transmitter module 100, and comprises an interface connector 220-1 for communicating with the reproduction transmitter module 100 via the wired communication. The digital audio data may be carried out via various communication modules included in the wired/wireless interface module 220. For instance, when the audio module controller 210 includes the bluetooth module 220-2 or the WiFi module, the digital audio data is transmitted as a digital signal. When the audio module controller 210 includes the RF module, the digital audio data may be modulated and transmitted, and the detachable audio module 200 may demodulated the digital audio data.

While FIG. 5 illustrates the wired/wireless interface module 220 including the WiFi module or the bluetooth module 220-2, a communication method is not limited to using these modules. A suitable communication module such as the RF module may be selected according to the communication method.

The interface connector 220-1 used as a path for transmitting the audio signal and the control signal via the wired communication and providing the power to the detachable audio module 200 as well as attaching the detachable audio module 200 to the reproduction transmitter module 100 mechanically. The interface connector 220-1 may include various connectors that facilitate attaching and detaching of the reproduction transmitter module 100 while providing a firm mechanical attachment.

As shown in FIG. 6, the amplifier module 230 comprises a DAC module 230-1 for converting the decoded audio signal into an analog signal and an analog amplifier 230-2 for amplifying the analog signal and outputting the amplified analog signal to a speaker.

In accordance with another embodiment of the present invention, the amplifier module 230 may comprise a digital amplifier 230-3 for outputting the decoded audio signal to the speaker.

Although not shown, the detachable audio module 200 in accordance with the present invention may comprise the built-in speaker 300 and the external speaker output interface module (an earphone connector, for instance) for playing back the signal being outputted from the amplifier module 230.

As described above, the detachable audio module and the media player including the same are advantageous in that a user may use the relatively heavy reproduction transmitter module and the relatively light detachable audio module separately such that a portability is improved and provides an effective listening.

In addition, the automatic wireless linking function removes a user intervention to facilitate the use of the media player.

Moreover, the bidirectional charging function provides an automatic charge of the rechargeable battery disposed in the detachable audio module to prevent a discharge of the battery.

In accordance with the present invention, the user may be provided with a hands-free phone call and an MP3 audio reproduction without controlling the detachable audio module or the reproduction transmitter module for the wireless communication and charging the battery.

Designers of different manufacturers of the media player may share the detachable audio module to reduce a manufacturing cost and improve a competitiveness.

What is claimed is:

1. A media player apparatus comprising:
a detachable audio module for receiving and playing back an audio signal; and
a reproduction transmitter module electrically connected to the detachable audio module for transmitting the audio signal and a control signal to the detachable audio module,
wherein the detachable audio module receives the audio signal and the control signal via a wired communication when attached to the reproduction transmitter module to reproduce the audio signal,
wherein the detachable audio module receives the audio signal and the control signal via a wireless communication when detached from the reproduction transmitter module to reproduce the audio signal, and
wherein the detachable audio module switches from the wired communication to the wireless communication when separated from the reproduction transmitter module.

2. The apparatus in accordance with claim 1, wherein the detachable audio module comprises:
an audio module controller for carrying out a control of the detachable audio module and decoding the received audio signal;
an amplifier module for amplifying the decoded audio signal;
a wired/wireless interface module for connecting to the reproduction transmitter module via the wired communication or the wireless communication; and
a power supply module for providing a power to the audio module controller, the amplifier module and the wired/wireless interface module.

3. The apparatus in accordance with claim 2, wherein the power supply module receives a power from a power supply means disposed in the reproduction transmitter module when the detachable audio module is connected to the reproduction transmitter module via the wired communication.

4. The apparatus in accordance with claim 2, wherein the power supply module comprises:
a rechargeable battery for storing a supplied power; and
a charger module for charging the rechargeable battery with a power provided from a power supply means disposed in the reproduction transmitter module according to a remaining amount of the supplied power in the rechargeable battery.

5. The apparatus in accordance with claim 4, wherein the charger module controls the power supply module in a manner that rechargeable battery is charged or provides the power to the power supply means disposed in the reproduction transmitter module according to the remaining amount of the supplied power in the rechargeable battery and a remaining amount of the power in the power supply means disposed in the reproduction transmitter module when the detachable audio module is connected to the reproduction transmitter module via the wired communication.

6. The apparatus in accordance with claim 2, wherein the power supply module further comprises a rechargeable power input for receiving an external power.

7. The apparatus in accordance with claim 2, wherein the detachable audio module further comprises a built-in speaker and an external speaker output interface module for playing back a signal being outputted from the amplifier module.

8. The apparatus in accordance with claim 1, wherein the detachable audio module further comprises a microphone for receiving a voice signal.

9. The apparatus in accordance with claim 2, wherein the wired/wireless interface module comprises at least one of a WiFi module, a bluetooth module and an RF module for communicating with the reproduction transmitter module, and comprises an interface connector for communicating with the reproduction transmitter module via the wired communication.

10. The apparatus in accordance with claim 2, wherein the amplifier module comprises:
a DAC module for converting the decoded audio signal into an analog signal; and
an analog amplifier for amplifying the analog signal and outputting the amplified analog signal to a speaker.

11. The apparatus in accordance with claim 2, wherein the amplifier module comprises a digital amplifier module for outputting the decoded audio signal to a speaker.

12. A detachable audio module detachable from a reproduction module, the audio module comprising:
a wired/wireless interface module for transceiving an audio signal and a control signal to and from the reproduction module via a wired communication or the wireless communication;
an audio module controller for carrying out a control of the detachable audio module and decoding the received audio signal;
an amplifier module for amplifying the decoded audio signal; and
a power supply module for providing a power to the audio module controller, the amplifier module and the wired/wireless interface module,
wherein the detachable audio module receives the audio signal and the control signal via the wired communication when attached to the reproduction module to reproduce the audio signal,
wherein the detachable audio module receives the audio signal and the control signal via a wireless communication when detached from the reproduction transmitter module to reproduce the audio signal, and
wherein the detachable audio module switches from the wired communication to the wireless communication when separated from the reproduction transmitter module.

13. The apparatus in accordance with claim 12, wherein the power supply module receives a power from a power supply means disposed in the reproduction module when the detachable audio module is connected to the reproduction module via the wired communication.

14. The apparatus in accordance with claim 12, wherein the power supply module comprises:
a rechargeable battery for storing a supplied power; and
a charger module for charging the rechargeable battery with a power provided from a power supply means disposed in the reproduction transmitter module according to a remaining amount of the supplied power in the rechargeable battery.

15. The apparatus in accordance with claim 14, wherein the charger module controls the power supply module in a manner that rechargeable battery is charged or provides the power to the power supply means disposed in the reproduction transmitter module according to the remaining amount of the supplied power in the rechargeable battery and a remaining amount of the power in the power supply means disposed in the reproduction transmitter module when the detachable audio module is connected to the reproduction transmitter module via the wired communication.

16. The apparatus in accordance with claim 12, wherein the power supply module further comprises a rechargeable power input for receiving an external power.

17. The apparatus in accordance with claim 12, further comprising a built-in speaker and an external speaker output interface module for playing back a signal being outputted from the amplifier module.

18. The apparatus in accordance with claim 12, wherein the wired/wireless interface module comprises at least one of a WiFi module, a bluetooth module and an RF module for communicating with the reproduction transmitter module, and comprises an interface connector for communicating with the reproduction transmitter module via the wired communication.

19. The apparatus in accordance with claim 12, wherein the amplifier module comprises:
a DAC module for converting the decoded audio signal into an analog signal; and
an analog amplifier for amplifying the analog signal and outputting the amplified analog signal to a speaker.

20. The apparatus in accordance with claim 12, wherein the amplifier module comprises a digital amplifier module for outputting the decoded audio signal to a speaker.
